(19) United States
(12) Patent Application Publication
(10) Pub. No.: US 2004/0004684 A1
(43) Pub. Date: Jan. 8, 2004

(54) Light diffusing film having electromagnetic wave blocking property

(76) Inventors: Gi-Mo Yang, Gumi-si (KR); Bum-Gook Lee, Gumi-si (KR)

Correspondence Address: David A.Einhorn, Esq., Anderson Kill & Olick, P.C., 1251 Avenue of the Americas, New York, NY, 10020, US

(21) Appl. No.: 10/612,640

(22) Filed: Jul. 1, 2003

(30) Foreign Application Priority Data
Jul. 2, 2002 (KR) 2002-0037830

(51) Int. Cl. G02F 1/1335

(52) U.S. Cl. 349/112

(57) ABSTRACT

A light diffusing film having excellent electromagnetic wave shielding and optical properties is disclosed, which comprises a transparent substrate, a light diffusing layer formed on at least one side of the transparent substrate; and a transparent conductive layer formed on the light diffusing layer by a dry coating process.

### FIELD OF THE INVENTION

The present invention relates to a light diffusing film having excellent electromagnetic wave blocking property.

### BACKGROUND OF THE INVENTION

Light diffusing films are used for uniformly spreading light from a light source in a lighting equipment for various displays, e.g., backlight.

As a light source of backlight, fluorescent, electro-luminescent and light emitting diode lamps are usually employed and, in particular, a cold cathode fluorescent lamp is widely used for its brightness and color reproducibility.

There are several types of backlight, e.g., direct type, edge light type and surface light source type, and a direct type backlight is appropriate for a display device required to have high brightness. A direct type backlight usually comprises a reflecting film disposed at the rear surface of a light source; and a light diffusing film, a prism sheet and a lamp cover successively laminated at the front surface of the light source.

Further, as an attempt to block electromagnetic waves generated from the light source, an electroconductive film having a resistance of several hundred ohm (Ω) is additionally disposed between the light diffusing film and prism sheet. FIG. 1 is a schematic cross-sectional view depicting a conventional direct type backlight, wherein a reflecting film (11) is disposed at the rear surface of light source (10), and a light diffusing film (12), an electroconductive film (13), prism sheets (14a and 14b) and a lamp cover (15) are successively laminated at the front surface of the light source (10).

The electrioconductive film is typically formed by depositing an electroconductive material such as indium tin oxide on a polyester base film. However, a backlight employing such a separate electroconductive film has poor optical properties, i.e., low brightness and color reproducibility.

Japanese Laid-open Patent Publication No. Hei 7-84103 discloses a method to improve antistatic property by wet coating an acrylate-based material on a light diffusing film. However, the light diffusing film having an acrylate layer coated thereon fails to provide satisfactory electromagnetic wave blocking ability due to an extremely high resistance of about 1×10⁷ Ω. Typically, it is known in the art that the film resistance should be less than 1,000 Ω for adequate electromagnetic wave shielding.

Further, Japanese Laid-open Patent Publication No. Hei 8-86906 discloses a light diffusing film comprising an oxide layer including SiO₂ and a light diffusing material layer sequentially formed on a polyethylene terephthalate (PET) base film. However, the electromagnetic wave blocking efficiency of this light diffusing film is not sufficient although the visible light transmittance is improved.

### SUMMARY OF THE INVENTION

Accordingly, it is an object of the present invention to provide a light diffusing film having an excellent electromagnetic wave shielding property without deteriorating optical properties such as brightness or color reproducibility of backlight.

In accordance with the present invention, a light diffusing film comprises a transparent substrate; a light diffusing layer formed on at least one side of the transparent substrate; and a transparent conductive layer formed on the light diffusing layer by a dry coating process.

### BRIEF DESCRIPTION OF THE DRAWINGS

The above and other objects and features of the present invention will become apparent from the following description of the invention, when taken in conjunction with the accompanying drawings, which respectively show:

FIG. 1: a schematic sectional diagram for a conventional direct type backlight; and

FIG. 2: a schematic sectional diagram for a backlight in accordance with the present invention.

### DETAILED DESCRIPTION OF THE INVENTION

A light diffusing film according to the present invention may be prepared by forming a transparent electroconductive layer on a conventional light diffusing film. Thus, the inventive light diffusing film comprises a light diffusing layer and a transparent conductive layer successively laminated on a transparent base film. When the inventive light diffusing films are employed for backlights, there is no need to insert a separate electroconductive film between the light diffusing film and prism film. Therefore, the light diffusing film of the present invention provides an excellent electromagnetic wave blocking property to a backlight without compromising the brightness and color reproducibility.

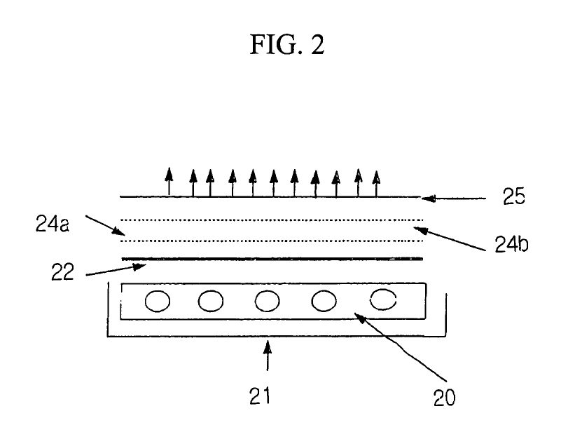

FIG. 2 depicts a schematic sectional view of a direct type backlight employing a light diffusing film in accordance with the present invention. As shown in FIG. 2, a reflecting film (21) is disposed at the rear surface of a light source (20), and a light diffusing film (22), prism sheets (24a and 24b) and a lamp cover (25) are successively laminated on the front surface of the light source (20). It is noted that a separate electroconductive film is not disposed between the light diffusing film (22) and prism sheets (24a and 24b).

The transparent base film may be a conventional film used in the art for preparing a light diffusing film. Preferred materials for the transparent base film include polyethyleneterephthalate, polycarbonate, polysulfone and polyethersulfone film.

The light diffusing layer may be formed on at least one surface of the transparent base film by a conventional method, for example, by homogeneously dispersing transparent resin particles, such as polymethylmethacrylate or polycarbonate beads, in an adhesive composition and coating the composition on the base film.

The transparent electroconductive layer may be formed on the light diffusing layer using a conductive material such as indium tin oxide (ITO), tin oxide (SnO₂), antimony tin oxide (ATO) and s metal, e.g., Au or Ag, by a physical or chemical deposition method which is based on sputtering, electron beam deposition, ion plating, spray pyrolysis or chemical vapor deposition. It has been unexpectedly found that an excellent electromagnetic shielding efficiency of more than 90%, which is corresponding to an electric resistance of not more than 1,000 Ω, can be obtained when the electroconductive layer is formed by a dry coating process instead of a wet coating method.

The thickness of the transparent conductive layer is about 5 to 200 nm, preferably 10 to 100 nm.

The inventive light diffusing film may be advantageously used for a backlight of liquid crystal displays (LCD), especially, a thin-film transistor (TFT) LCD, since it is possible to block electromagnetic waves with a high efficiency of more than 90% without sacrificing brightness.

The present invention is further described and illustrated in Examples, which are, however, not intended to limit the scope of the present invention.

### EXAMPLE

A conventional light diffusing film, i.e., a 125 μm-thick PET film having a 20 nm-thick acrylate light diffusing layer coated thereon was pretreated using plasma, and then, a 100 nm-thick ITO layer was formed on the light diffusing layer by means of at 5˜20 KW and 1˜5×10⁻³ mbar. The electric resistance of the resulting light diffusing film was measured to be 500 Ω. Using the light diffusing film thus prepared, a direct type backlight as shown in FIG. 2 was assembled.

### Comparative Example 1

A 100 nm-thick ITO layer was formed on a conventional light diffusing film used in Example by coating an ITO solution (15% by volume ITO in ethyl alcohol) on the light diffusing layer. The electric resistance of the resulting light diffusing film was measured to be 1×10⁷ Ω. Using the light diffusing film thus prepared, a direct type backlight as shown in FIG. 2 was assembled.

### Comparative Example 2

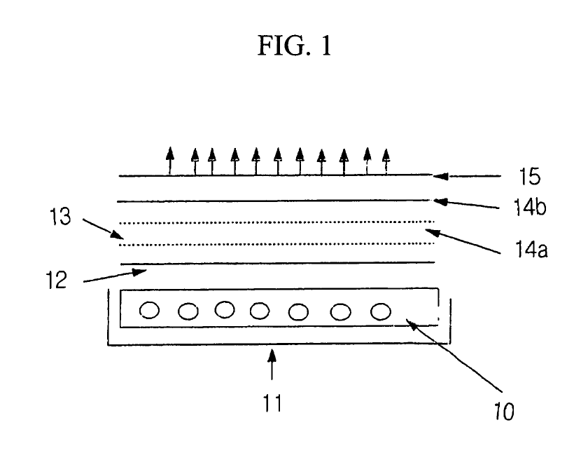

On a 125 μm-thick PET film, a 100 nm-thick ITO layer was formed by sputtering under the same condition as in Example to obtain a separate electroconductive film. Using the electroconductive film thus prepared, a direct type backlight as shown in FIG. 1 was assembled.

The backlights prepared in Example and Comparative Examples 1 and 2, were examined for the electromagnetic wave blocking efficiency, surface resistance, total and spectral transmittances and brightness and the result is shown in Table 1.

TABLE

| | Example | Com. Example 1 | Com. Example 2 |
|---|---|---|---|
| Electromagnetic wave | 90% | 0% | 90% |
| blocking | | | |
| Surface resistance | 267 Ω | 390 Ω | 300Ω |
| Total transmittance | 90.8% | 86.5% | 91 ± 3% |
| Spectral transmittance | 88.6% | 86.4% | 90 ± 3% |
| (550 nm) | | | |
| brightness | Good | — | Bad |

The electromagnetic wave blocking efficiency was measured by converting resistance of a light diffusion film measured with a 4-point probe. The surface resistance of a backlight was also measured with a 4-point probe. The total transmittance was measured with a hazemeter (JIS K-7105), and the spectral transmittance, with a spectrophotometer.

As can be seen from Table 1, the backlight of Example employing a light diffusing film in accordance with the present invention was superior in terms of the overall performance characteristics including electromagnetic wave blocking efficiency and optical properties as compared with the comparative backlights.

While the invention has been described with respect to the above specific embodiments, it should be recognized that various modifications and changes may be made to the invention by those skilled in the art which also fall within the scope of the invention as defined by the appended claims.

What is claimed is:

1. A light diffusing film comprising:
a transparent substrate;
a light diffusing layer formed on at least one side of the transparent substrate; and
a transparent conductive layer formed on the light diffusing layer by a dry coating process.

2. The light diffusing film of claim 1, wherein the transparent conductive layer is formed by a physical or chemical deposition method.

3. The light diffusing film of claim 1, wherein the transparent conductive layer comprises at least one material selected from the group consisting of indium tin oxide (ITO), tin oxide (SnO₂), antimony tin oxide (ATO) and metal.

4. The light diffusing film of claim 1, wherein the thickness of the transparent conductive layer is 5 to 200 nm.

5. The light diffusing film of claim 2, wherein the physical or chemical deposition method is base on sputtering, electron beam deposition, ion plating, spray pyrolysis or chemical vapor deposition.

6. The light diffusing film of claim 1, wherein the film has an electric resistance of 1,000 ohm (Ω) or less.

7. A liquid crystal display device comprising a backlight employing a light diffusing film of claim 1.
